(19) United States
(12) Patent Application Publication
(10) Pub. No.: US 2008/0291985 A1
(43) Pub. Date: Nov. 27, 2008

(54) AGILE SPECTRUM MONITORING IN A RADIO TRANSCEIVER

(76) Inventors: Nikhil Adnani, Ottawa (CA); Philip Vigneron, Kanata (CA); Colin Brown, Ottawa (CA); Andre Louzada Brandao, Ottawa (CA)

Correspondence Address: TEITELBAUM & MACLEAN, 280 SUNNYSIDE AVENUE, OTTAWA, ON, K1S 0R8, CA

(21) Appl. No.: 12/125,503

(22) Filed: May 22, 2008

Related U.S. Application Data
(60) Provisional application No. 60/939,630, filed on May 23, 2007.

(51) Int. Cl. H04B 1/38

(52) U.S. Cl. 375/220; 375/130

(57) ABSTRACT

The invention relates to a method and an apparatus for agile RF spectrum monitoring in a radio system with dynamic frequency access. It provides a spectrum monitor based on non-coherent heterodyne detection that utilizes a DDS signal generator to digitally generate a reference signal at a variable reference frequency for mixing with an input RF signal received from an RF antenna, a pass-band filter and a log amplifier for obtaining energy estimates at a monitored transmission frequency corresponding to the reference frequency. A processor is provided for adaptively selecting sets of monitored transmission frequencies, for controlling the DDS signal generator, and for processing obtained spectral energy estimates to assess spectral usage data.

### CROSS-REFERENCE TO RELATED APPLICATIONS

The present invention claims priority from U.S. Provisional Patent Application No. 60/939,630 filed May 23, 2007, entitled “A Prototype Hardware Cognitive Radio For Communications In An Interference Environment, Spectrum Scan Technique”, which is incorporated herein by reference for all purposes.

### TECHNICAL FIELD

The present invention generally relates to radio transmission systems with adaptive spectrum utilization, and more particularly relates to a method and an apparatus for scanning of a radio frequency transmission spectrum in a cognitive radio transceiver.

### BACKGROUND OF THE INVENTION

The scarcity of available frequencies for RF (radio frequency) transmission, with a wide frequency bands already allocated to so-called primary RF users such as TV and radio broadcasters and cell phone operators, has become a major problem for deployment of new wireless transmission systems. On the other hand, spectrum utilization measurements indicate that frequencies allocated in these licensed bands are largely under-utilized. For example, some measurements showed that less than 10% of spectrum was in use in the US for the frequency band below 3 GHz.

A similar problem is encountered by wireless ad-hoc communication networks, for example when they operate in unplanned scenarios, such as natural disasters or rapid deployments, with multiple such wireless subnetworks (subnets) operating in the same geographical area. This may include the case where a mobile subnet moves into the range of other operating subnets. Other sources of interference for a wireless ad-hoc network are radio emissions that share the same frequency band but may not belong to any subnet, which will also adversely impact communications.

The scarcity of spectrum licensing and under-utilization of licensed bands motivate the development of radio systems utilizing dynamic spectrum access, which allows un-licensed wireless applications to operate in the licensed bands while insuring no harmful interference to the incumbent users in the licensed bands, and would allow multiple ad-hoc networks to operate in the same geographical area. One such recently introduced technology, which enables efficient spectrum utilization by providing for dynamic spectrum resource management, is commonly referred to as cognitive radio (CR). By adopting dynamic spectrum resource management, a CR system enables RF frequency band sharing between multiple users, and provides for the use of unoccupied spectrum segments, while guaranteeing the rights of primary users.

The term “cognitive” in this context is understood as pertaining to cognition, or to the action or process of knowing the transmission environment that a CR radio transmitter encounters. A CR transmitter can sense its environment and alter its technical characteristics and operational behavior to benefit both itself and its geographical and spectral neighbors. The ability to sense and respond intelligently distinguishes cognitive radios from fixed radios, which characteristics are set at the time of manufacture. A cognitive radio can respond intelligently to an unanticipated event; i.e., a wireless environment (channel) that it never encountered before. The result is enhanced performance (throughput, quality of service (QOS), and security) for the cognitive radio's network and reduced interference to other networks.

In order to mitigate the effects of interference in a CR network, transmission parameters such as bandwidth, centre frequency, signal power, duration of signal transmission, modulation, and specifics of spreading or hopping are not fixed as in conventional radio systems. Instead, each radio receiver or user terminal first monitors the spectrum to determine both spectrum availability and activity. Each terminal's view of the radio environment may be different on account of its relative proximity to sources of interference or even differing sensitivity and sophistication of detection hardware. Each terminal receiver can determine regions of low spectral occupancy, or grey space, in the spectrum as a function of time. The terminal can then sort the grey regions in a probabilistic manner. The CR network may then use the information gathered by all radios to develop a spectrum occupancy plan for the subnet. The ability to observe the spectrum and adapt to it in a network-wide optimal manner to enable communications and optimize system throughput is an important advantage of the CR technology.

In order to allocate unused spectrum resources, CR systems must include a spectrum sensing technique to accurately and quickly identify the spectrum usage status over a wide frequency range covering various communication standards. Moreover, the spectrum sensing techniques should preferably consume little power, have a relatively short latency and be easy to implement.

However, prior spectrum-sensing techniques and devices such as spectrum analyzers are complex, expensive and often require complicated and time-consuming processing of measured data, which makes the spectrum sensing in CR radios too slow to reflect fast-changing environment, or makes the CR transmitters too expensive or heavy for mobile use.

An object of the present invention is to overcome at least some of the shortcomings of the prior art by providing relatively simple and computationally inexpensive method and apparatus for dynamic spectrum monitoring in CR transmission systems and mobile CR transceivers.

### SUMMARY OF THE INVENTION

Accordingly, one aspect of the invention provides a method for spectrum monitoring in a radio transceiver utilizing dynamic spectrum allocation for radio transmission, the method comprising the steps of: (a) digitally synthesising a reference signal at a variable reference frequency corresponding to a monitored transmission frequency; (b) mixing the digitally synthesized reference signal with an input radio signal received from an RF antenna to obtain a difference frequency signal; (c) detecting the difference frequency signal at a detection frequency to obtain an estimate of the spectral energy of the input radio signal at the monitored transmission frequency; and, (d) determining the availability of the transmission frequency using the spectral energy value.

The method may further includes the steps of: (f) repeatedly performing the sequence of steps (a)-(c) while stepping the reference frequency through a plurality of reference frequency values so as to obtain spectral energy estimates for a plurality of monitored transmission frequencies; (g) analyzing spectral energy estimates obtained in step (f) to obtain spectral and/or temporal usage data for the plurality of monitored transmission frequencies; (h) adaptively changing the plurality of reference frequencies based upon the spectral and/or temporal usage data obtained in step (g); and, (h) repeating step (f) to obtain spectral and/or temporal usage data for a different plurality of monitored transmission frequencies.

Another aspect of this invention provides a spectrum monitor in a mobile radio transceiver utilizing dynamic spectrum allocation and having a digital data processing and control (DDPC) section, an RF receiver section, and an RF transmitter section, the spectrum monitor comprising: a direct digital synthesis (DDS) signal generator for digitally synthesizing a reference signal at a variable reference frequency corresponding to a monitored transmission frequency; an RF mixer connected to receive an input RF signal and the reference signal to output a mixed signal comprising a difference frequency signal; a nonlinear device coupled to the RF mixer to receive the difference frequency signal for obtaining therefrom energy estimates for the input RF signal at the monitored transmission frequency in a selected measurement bandwidth; an analogue to digital converter (ADC) for converting the detected signal into the digital domain; and, a spectrum processing module within the DDPC section, the spectrum processing module coupled to the DDS signal generator and the ADC for controlling the variable reference frequency and for storing and processing the energy estimates.

According to one feature of the invention, the spectrum processing module is programmed to adaptively select a set of monitored transmission frequencies and a corresponding set of reference frequencies for providing said references frequencies to the DDS signal generator for stepping therethrough, and to record energy estimates obtained from the nonlinear device for estimating spectral and/or temporal occupancy pattern for the selected set of monitored transmission frequencies.

### BRIEF DESCRIPTION OF THE DRAWINGS

The invention will be described in greater detail with reference to the accompanying drawings which represent preferred embodiments thereof, in which like elements are identified with like reference numerals, and wherein:

FIG. 1 is a block diagram of a CR transceiver according to the present invention;

FIG. 2 is a block diagram of a spectrum monitor according to the present invention;

FIG. 3 is a flowchart of a method for spectrum monitoring in a CR communication system according to the present invention; and,

FIG. 4 is a schematic diagram of an exemplary spectrum monitoring scenario.

### DETAILED DESCRIPTION

The invention will be described in connection with a number of exemplary embodiments. To facilitate an understanding of the invention, many aspects of the invention are described in terms of sequences of actions to be performed by functional elements of a radio transceiver utilizing dynamic spectrum allocation. It will be recognized that in each of the embodiments, the various actions including those depicted as blocks in flow-chart illustrations and block schemes could be performed by specialized circuits, for example discrete logic gates interconnected to perform a specialized function, by computer program instructions being executed by one or more processors, or by a combination of both. Thus, the various aspects of the invention may be embodied in many different forms, and all such forms are contemplated to be within the scope of the invention.

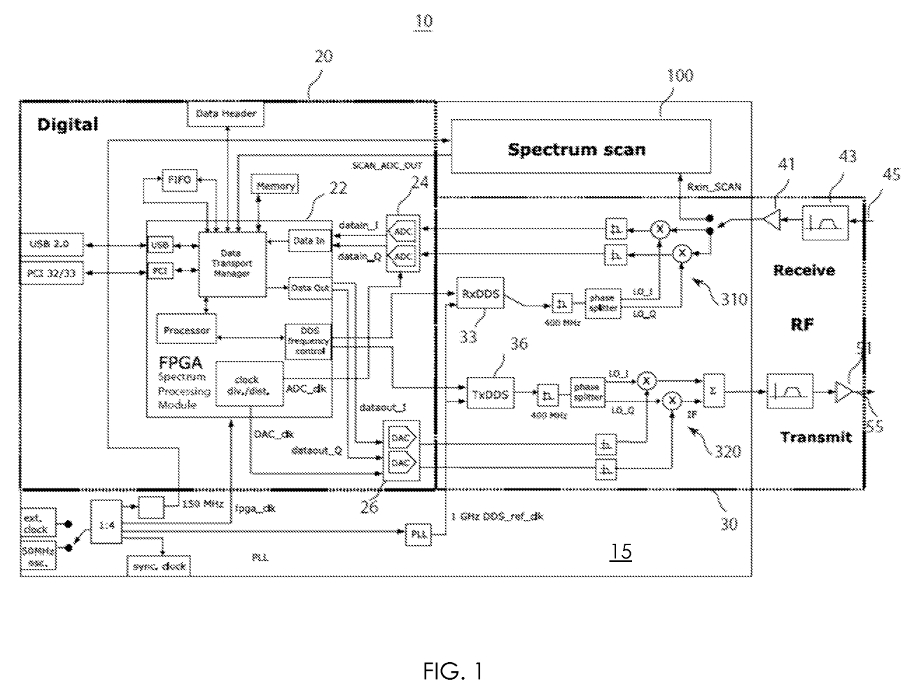

The apparatus and method of RF spectrum monitoring of the present invention will be described hereinbelow with reference to an exemplary CR transceiver (CRT) 10, which functional layout is shown on a block diagram of FIG. 1. The CRT 10 includes three main sections, an RF section 30 for demodulating input RF signals 45 and modulating output RF signals 55, a digital data processing and control (DDPC) section 20 containing processing means 22 embodied as a field programmable gate array device (FPGA) for signal routing and some signal processing, and a spectrum scan section 100, also referred to herein as the spectrum monitor 100, for conducting timely low complexity RF spectrum analysis. In a prototype exemplary embodiment designed by the inventors all these sections reside on a single 14-layer board 15, where digital and analog signals are isolated and shielded. The exemplary CRT 10 also includes two broadband interfaces with a host processor that is not shown. The host processor generates bit streams to be transmitted by the transceiver, and processes received bit streams; it may be co-located with the transceiver 10 on the same board or on a different board within a same housing, or may be located separately, and may host user applications such as voice- and video-codecs, browser, etc. The CRT 10 is fully reconfigurable in software, and is therefore based on a software-defined radio architecture. Digital filtering can also be performed in the host processor or the FPGA 22. Local oscillators 33, 36 used for up- and down-conversion, and for spectrum scanning, are digital, and are therefore programmable via the FPGA 22. The CRT 10 also includes on-board processors residing in the FPGA 22 to enable the computation associated with cognition.

### The Radio Section

The radio section 30, also referred to herein as the RF section 30, includes a downlink, or receive (Rx) portion 310 for receiving the input RF signal 45 from an RF antenna, and an uplink, or transmit (Tx) portion 32 for transmitting the output RF signal 55 through the same or different RF antenna. In the scenarios wherein multiple terminals such as the CRT 10 are communicating at the same time, it is preferable to use front-end analog filters 43, 53 that cover non-overlapping bands for the uplink and downlink communications in order to reduce co-site problems where the transmitted signal floods the receiver on the same transceiver. Alternately, the uplink and downlink portions 320, 310 can utilize the same frequency band in a duplexed manner. In this case the front-end filters 43 and 53 may cover the same frequency band.

The radio section 30 of the CRT 10 in its shown embodiment utilizes a direct-conversion or a homodyne architecture based on local oscillators (LO) 33, 36 embodied as direct digital synthesizers (DDS), rather than a conventional super-heterodyne design for the receiver, which however may also be used in other embodiments. One reason for choosing the direct-conversion architecture is that it eliminates the requirement for an image-reject filter. This becomes especially useful when the contiguous bandwidth of the downlink or uplink portions 310, 320, and therefore the bandwidth of the RF pre-selection filters 43, 53, is increased to allow for hopping over a larger range of frequencies. Other advantages of the direct-conversion architecture include: a potential reduction in the analog-to-digital converter (ADC) sampling rate because the sample and hold operations are conducted at baseband, fewer parts resulting in lower cost, and a suitability of homodyne receivers to monolithic integration. The use of the DDS 36 as the local oscillator in the transmitter portion 320 overcomes the phenomenon of injection locking that is a known problem for direct-conversion schemes that utilize voltage controlled oscillators.

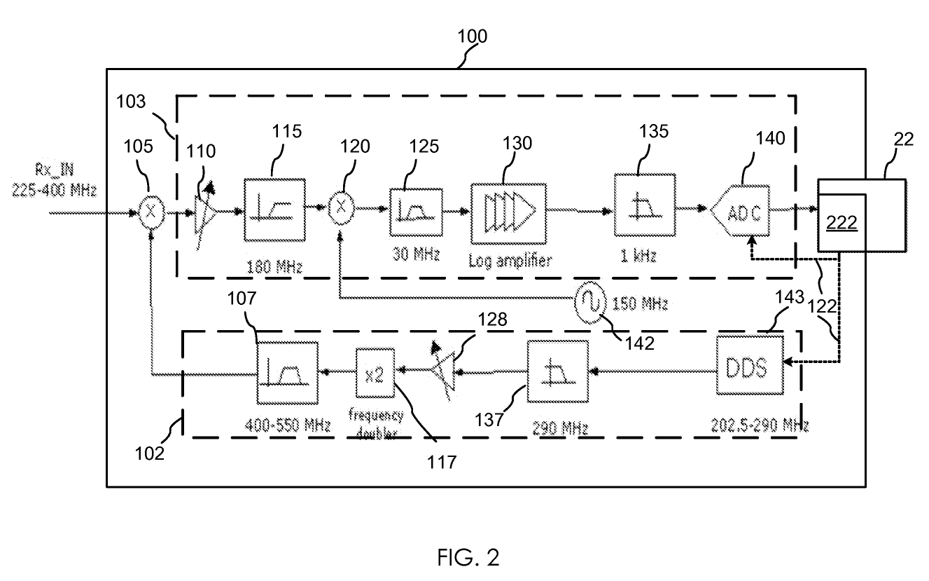

The DDS 33 and 36, also referred to as the Rx DDS and the Tx DDS, respectively, are used to generate frequency hopping RF carriers in the 225-400 MHz band for the Rx portion 310 and the Tx portion 320 of the RF section 30. In one embodiment, the output of the Rx DDS 33 can be switched to provide a digitally synthesized reference signal at a selected reference frequency to the spectrum monitor 100 for mixing with the input RF signal, as described hereinbelow. In that embodiment, the spectrum monitor 100 and the Rx portion 310 operate in alternating time slots. In a more preferred embodiment described hereinbelow with reference to FIG. 2, the spectrum monitor includes a dedicated DDS, so that it can operate to sense the RF spectrum while the CRT 10 is receiving and demodulating the input RF signal. Each of the DDS 33, 36 utilizes a precision reference clock and a look-up table to synthesize a digital representation of a sinusoid with programmable phase offset and frequency, and at its final stage includes a digital-to-analog converter (DAC) which it uses to generate an analog equivalent of the digital word. The ability to generate fast, phase-continuous frequency hops with a DDS results in greater data throughput than with an analog phase-locked loop (PLL) based carrier. This is because the DDS has improved loop settling time during which data cannot be transmitted or received, as compared to local oscillators based on analog PLLs. Additionally, the use of a coherent analog receiver would lead to phase discontinuities at each hop and therefore require more frequent channel estimation. One disadvantage of the use of the DDS as the LO in homodyne detection is the presence of spurious tones, or spurs, in the output spectrum as a result of phase truncation, DAC nonlinearity and switching transients and clock feed through. This however may not be a significant problem in the frequency hopping system as the spur frequencies are for the most part deterministic and not constant in magnitude for frequencies programmed across the band. Spur frequencies and magnitudes can therefore be characterized and hop frequencies can be adjusted to minimize spurs.

The transmit 320 and receive 310 chains of the radio section 30 also include quadrature modulator and demodulator, respectively, each of which utilizes two RF mixers preceded by a phase splitter connected to receive the LO carrier from the respective DDS 33 or 36. The output of the demodulator and input to the modulator connect each to paired analog to digital converters (ADC) 24 and digital to analog converters (DAC) 26, respectively, in the digital section 20 of the CRT 10.

### The Digital Section

The DDPC section includes two 10-bit ADCs 24 on the receive path, and two 10-bit DACs 26 on the transmit path for the I and Q baseband waveforms. In the exemplary embodiment described herein, the ADCs 24 and the DACs 26 can be clocked at a rate of 40 MHz which is adequate for the bandwidths expected of terrestrial wideband waveforms. Central to the digital section 20 is the processor means 22, which in the shown embodiment is in the form of an FPGA, but can also be a microprocessor, a general purpose processor or a combination of some or all of the above. The processor 22, which is hereinafter referred to as the FPGA 22, perform functions that may include the following: i) managing the flow of data into the DACs 28 and out of the ADCs 24, and managing the flow of data from the spectrum monitor 100, ii) buffering and controlling data flow across interfaces with the host processor, iii) control and monitoring of the Rx DDS 33, Tx DDS 36 and a DDS that may be included in the spectrum monitor 100 as described hereinbelow, iv) debugging, v) processing spectral energy estimates obtained from the spectrum monitor 100 to evaluate spectral usage data and patterns, vi) controlling various switches and attenuation settings, vii) multiplying and dividing an on-board 50 MHz reference clock or an external reference clock to provide sampling clocks for the ADCs and DACs, and viii) accessing off-chip memory elements.

The board 15 includes three standard digital interfaces into the host processor, namely Peripheral Component Interconnect (PCI), Universal Serial Bus (USB 2.0) and RS-232. The RS-232 interface may be used primarily for communicating with the FPGA during testing activities prior to using the other two interfaces. A dual-directional hardware first-in first-out (FIFO) chip is used to manage the flow of data between the FPGA and the USB or PCI interfaces, e.g. for rate matching across two different clock domains and to act as a buffer in the event of latencies caused as a result of the host processor responding to other processing tasks.

### Spectrum Monitor

FIG. 2 shows an exemplary functional layout of the spectrum monitor (SM) 100 in one embodiment thereof. The SM 100 utilizes a non-coherent heterodyne technique to monitor spectral power of an input RF signal Rx_IN received from an RF antenna (not shown) of the CRT 10, in an operating band (Fmin, Fmax) of the CRT 10. The non-coherent power measurement provides instantaneous snapshots of the spectral occupancy which enable the CRT 10 to plan its spectrum use. By way of example, the circuit shown in FIG. 2 is suitable to monitor the spectral occupancy of the radio environment over a 225-400 MHz tactical UHF band, with Fmin=225 MHz, Fmax=400 MHz. It includes a first RF mixer 105 that connects at its inputs to the RF antenna (not shown) of the CRT 10 and to a DDS-based local oscillator circuit (DLOC) 102, and at its output to a spectrum measurement circuit (SMC) 103. The DLOC 102 includes a DDS 143, which connects to a first low-pass filter (LPF) 137, sequentially followed by a variable gain amplifier 128, a frequency doubler 117, and a first band-pass filter (BPF) 107. The SMC 103 includes another variable gain amplifier 110, which is followed sequentially by a high-pass filter 115, and a second RF mixer 120 that is coupled at its second input to a fixed-frequency local oscillator 142. The output of the second RF mixer connects to a second BPF 125, which in turn connects to a nonlinear device 130 such as a logarithmic amplifier, or logamp, followed by an optional smoothing LPF 135, and an ADC 140. An output of the ADC 140 is coupled to one of the input ports of the FPGA 22 and feeds into a spectrum processing module (SPM) 222, which may be defined within the FPGA 22 using conventional FPGA programming means. The SPM 222 controls the operation of the ADC 140 and the DDS 143 and is therefore considered to be a part of the SM 100.

In a frequency scan mode, the DDS 143 generates a reference signal R_{ef}, which is a narrow-band RF carrier sigan1 centered at a variable reference frequency f_{ref}, upon receiving a control word from the FPGA 22 specifying a particular value of f_{ref}. This reference signal is then frequency doubled by the frequency doubler 117, and optionally amplified by the amplifier 128. The first LPF 137 rejects DDS generated frequencies above an upper reference frequency limit f_{refMax} to reduce the DDS phase noise, while the first BPF 107 removes undesirable higher-order harmonics that may have been generated from the reference signal by the frequency doubler 117, along with any low-frequency noise corresponding to reference frequency values below a lower reference frequency scan limit f_{refMin}. In the shown embodiment, the upper and lower reference frequency limits f_{refMax}, f_{refMin}, relate to the upper and lower limits of the measured RF frequency band Fₘₐₓ and Fₘᵢₙ as follows:

2f_{refMax}=Fₘₐₓ+f_{IF}, (1a)

2f_{refMin}=Fₘᵢₙ+f_{IF}. (1b)

Here f_{IF} is the intermediate, or difference, frequency, which satisfies in turn the following equation:

f_{IF}=f₁+f_{det}, (2)

where f₁ is the frequency of a RF carrier generated by the second LO 142, and f_{det} is a detection frequency, i.e. the frequency at which the passband of the PBF 125 is centered. The second LO 142 may be based on a DDS, so that f₁ can be digitally tuned as required prior to a frequency scan. In the exemplary embodiment now described, the operating frequency band of the CRT 10 is We found that for monitoring the RF transmission band from Fₘᵢₙ=225 MHz to Fₘₐₓ=400 MHz with the SM 100 as shown in FIG. 2, suitable choices of the intermediate and detection frequencies are f_{iF}=180 MHz and f_{det}=30 MHz, which may be selected taking into account cutoff frequencies of commercially available RF filters, resulting in f₁=150 MHz.

The first RF mixer 105 receives the input RF signal Rx_IN having a spectral power density Rx_IN(f) and the frequency-doubled reference signal R_{ef} and provides to the SMC 103 a mixed RF signal, which includes a difference frequency signal D_{iff} with a spectral power density that is proportional to that of the input RF signal down-shifted in frequency by 2f_{ref}, D_{iff} (f)˜Rx_IN(f−2f_{ref}). This difference frequency signal is filtered by the high-pass filter 115 to reject an image frequency, which in this embodiment may be at about 120 MHz, and to pass through a signal at the intermediate frequency, which is 180 MHz in the described embodiment. In the second RF mixer 120 the difference frequency signal is downconverted in frequency by mixing it with the second reference signal at the second LO frequency f₁, and the result is passed through the BPF 125, which has a passband of width Δf_{det} centered at a chosen detection frequency f_{det}. The bandwidth Δf_{det} of the BPF 125 determines the spectral resolution of the measurements and is referred to hereinafter as the detection bandwidth. The filtered and downconverted difference-frequency signal is then passed to the logamp 130 for obtaining therefrom a detected signal in the form of the logamp 130 output voltage; this detected signal is generally proportional to the energy of the difference frequency signal D_{iff} within the selected detection bandwidth Δf_{det}. The ADC 140 samples the output voltage of the logamp 130 smoothed by a low-pass filter 135, and transfers its digital equivalent to the SPM 222 for further processing.

As the skilled reader will appreciate, the digitized detected signal E=E(fₘₑₛ) at the output of the ADC 140 is proportional to the energy of the input signal Rx_IN at a measurement frequency fₘₑₛ:

E(fₘₑₛ)˜Rx_IN(fₘₑₛ)·Δf_{det}, (3)

fₘₑₛ=n·f_{ref}−f_{IF}. (4)

In equation (4), the frequency multiplier n=2 represents the doubling of the reference frequency by the frequency doubler 117. Other embodiments can utilize alternative nonlinear frequency multiplying elements or cascades of frequency doublers resulting in n>2. The digitized detected signal E, which is read by the SPM 222 from the output of the ADC 140, is also referred to hereinafter as the spectral energy estimate for the respective measurement frequency fₘₑₛ, or simply as the energy estimate. The energy estimate is thus a quantity proportional to the spectral power density of the input RF field at a respective measurement frequency, but includes effects of scaling, ADC word length, etc.

The detection bandwidth Δf_{det} can be for example 25 KHz-100 KHz for detecting narrow-band signals, and 1-5 MHz for detecting wide-band signals, although other suitable detection bandwidths could also be envisioned depending on application. In some embodiments, a switchable bank of filters of different bandwidth or a variable bandwidth switched-capacitor bandpass filter can be used in place of the BPF 125 to enable measurements with different spectral resolutions.

In one embodiment, the SPM 222 computes a short-term time average of the detected signal energy at the measurement frequency fₘₑₛ, which is then stored in RAM in relation to the measurement frequency and a time instance tₘₑₛ at which the measurement has been performed. Tables or probability density functions of these energy values obtained at a plurality of measurement frequencies and/or time values may then be computed by the SPM 222.

The ADC 140 and DDS 143 are controlled by the SPM 222 using control lines 122, so that spectrum measurements can be taken at a desired measurement frequency fₘₑₛ within the operation band of the CRT 10 by setting the control word of the DDS 143 to define a respective reference frequency value, and at a desired time instance tₘₑₛ by activating the ADC 140 at that instance.

Advantageously, the spectrum monitor 100 of the present invention can be constructed using relatively small number of inexpensive off-the-shelf RF components which add little to the cost and weight of the CRT 10, making it suitable for use in mobile and hand-held CR communication terminals. Furthermore, it enables agile spectrum monitoring, wherein measurement frequencies can be easily a quickly changed, and spectrum measurement plans tuned to changing RF environment to determine spectrum usage patterns and adapt transmission frequencies of the transceiver 100 thereto. This agility of the spectrum monitor 100 is enabled by low latencies of the components used in the circuit of FIG. 2, and the ability to adaptively select transmission frequencies for monitoring. By way of example, AD9858 may be used as the DDS 143, AD8310 may be used as the Logamp 130, AD7476 may be used as the AD 140, all from Analog Devices, and an FPGA CYCLONE II, part #EP2C50F672C6, from Altera may be used as the FPGA 22. A delay time associated with switching of the DDS 143 to another reference frequency may be about 0.7 millisecond (ms), settling time of the logamp 130 output is about 40 nanoseconds (ns), the ADC acquisition time of about 1.3 microsecond (μs) or less, a minimum rise/fall time associated with the optional smoothing filter 135 1 ms, providing an overall measurement latency on the order of 1 ms: the smoothing filter 135 can be removed or replaced with a wider bandpass filter or with a suitable smoothing algorithm programmed in the SPM 222 for a faster response.

Accordingly, an aspect of the present invention provides a method of agile non-coherent spectrum monitoring in a radio transceiver that utilizes dynamic spectrum allocation, such as the CRT 10, wherein spectral occupancy of the input RF signal within the transceiver operating range is sensed by mixing the input RF signal with a digitally synthesized reference signal that steps through a set of adaptively selected reference frequencies.

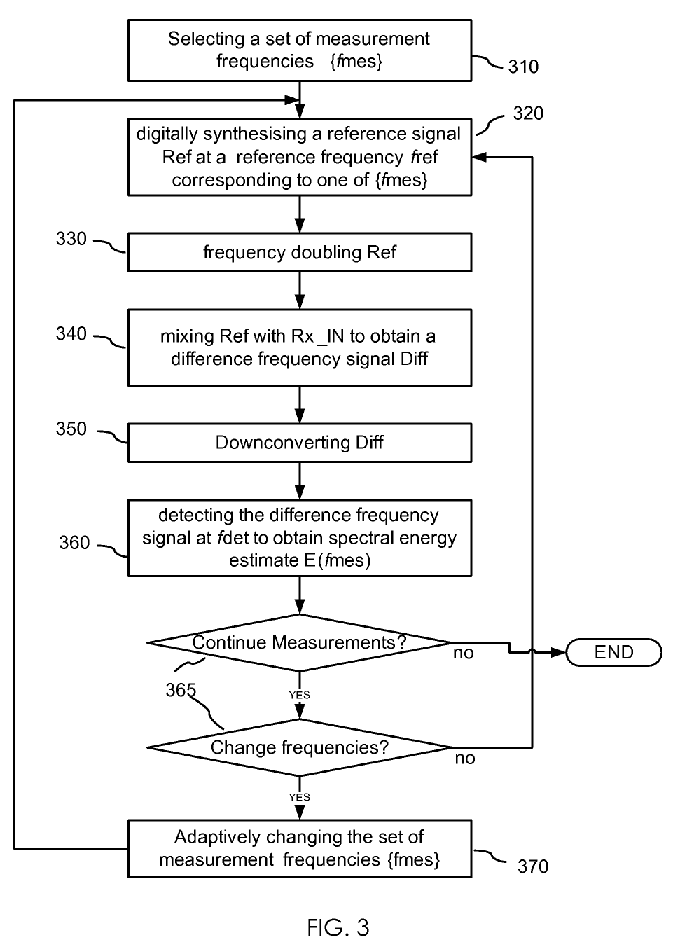

One embodiment of the method for spectrum monitoring according to the present invention will now be described with reference to a flowchart shown in FIG. 3, and FIGS. 1 and 2. As shown in FIG. 3, the method may include the following steps:

First, in a step 310 a plurality, or set, of measurement frequencies {fₘₑₛ} is selected for monitoring among all possible transmission frequencies within the transmission band of the CRT 10. These measurement frequencies are also referred to herein as monitored transmission frequencies. They can be selected or otherwise obtained in different ways; for example initially the set {fₘₑₛ} may include all possible transmission frequencies, or it may be provided by a host application such as a base station, or it can be adaptively obtained as explained hereinafter in this application. Once the set of measurement frequencies {fₘₑₛ} is obtained, a corresponding set of reference frequencies {f_{ref}} is computed by the SPM 222, for example using equation (4), and stored in memory. The set of measurement frequencies {fₘₑₛ} may be referred to herein as a measurement plan, and the process of obtaining energy estimates for each of the measurement frequencies {fₘₑₛ} by sequentially stepping therethrough may be referred to as a spectrum scan. In some embodiments both sets of frequencies {fₘₑₛ} and {f_{ref}} may be stored in memory, either directly by storing a digital equivalent of each frequency, or in any other suitable way, for example they may be defined by a minimum frequency fₘᵢₙ from the set, a frequency increment δf, and a number N of frequencies in the respective set, which may be stored in memory so that each of the frequencies f_{ref} can be computed in real time as the measurements proceed.

In a next step 320, a periodic reference signal Ref is digitally synthesized at a reference frequency f_{ref} corresponding to one of the measurement frequencies {fₘₑₛ}. This step may include generating by the SPM 222 a control word specifying the reference frequency f_{ref}, and passing it to the DDS 143 at a specified time instance t_{DDS}.

The digitally synthesized reference signal R_{ef} is then optionally frequency doubled in step 330, and mixed in a step 340 with the input radio signal Rx_IN received from the RF antenna, so as to obtain a difference frequency signal D_{iff} as described hereinabove with reference to FIG. 2.

In steps 350 and 360 the difference frequency signal is first optionally down-converted to a detection frequency f_{det}, filtered to remove all spectral components but those at or near the detection frequency, and then detected by a nonlinear detector such as the logamp 130 to obtain an energy estimate of the spectral energy of the input radio signal at the measured frequency fₘₑₛ selected in step 320. This energy estimate may be stored by the SPM 222 in memory in relation to the monitored transmission frequency fₘₑₛ or the respective reference frequency f_{ref}, and used to determine the availability of the measurement frequency fₘₑₛ for transmission, for example by comparing it to a pre-determined threshold value to detect whether the frequency is used by an external transmitter and to avoid interference.

The sequence of steps 320-360 is then repeated for each measurement frequency from the set {fₘₑₛ} by stepping the reference frequency through the plurality of reference frequency values {f_{ref}}, so as to obtain a spectral energy estimate for each of the plurality of monitored transmission frequencies.

Once the measurement at each of the measurement frequencies is completed, the obtained energy estimates may be stored in memory in relation to the respective measurement frequencies and, optionally, in relation to time instances at which the measurements at particular frequencies were performed, which may correspond to time instances when the energy estimates are read from the ADC 140, with the plurality of the obtained energy estimates in relation to the respective measurement frequencies and time instances forming a virtual measurement table.

In a next step 365, the spectral energy estimates obtained in step 360 are analyzed in the SPM 222 to obtain spectral and/or temporal usage data for the plurality of monitored transmission frequencies {fₘₑₛ}. This data may, for example, include i) a first list of frequencies that are estimated to be available for transmission, ii) a second list of frequencies that require further monitoring and analysis, and/or iii) a third list of frequencies that are considered to be occupied and cannot be currently used for transmission. In one embodiment, the analysis may include ranking the measured frequencies in ascending order of energy estimates, and assigning measurement frequencies with the highest ranking to the first list of frequencies available for transmission.

Based on this usage data, in step 370 the set of monitored transmission frequencies {fₘₑₛ}, together with the set of reference frequencies {f_{ref}} corresponding thereto, may be adaptively changed by the suitably programmed SPM 222 to a different set of monitored transmission frequencies, for example as defined by the third list of measurement frequencies, after which steps 320-365 may be repeated to obtain spectral and/or temporal usage data for the new set of monitored transmission frequencies.

In one embodiment, a spectrum measurement process, or a spectrum scan, may include i) storing a virtual measurement table defining a series of time and frequency instants in FPGA readable memory, ii) calculating control words corresponding to the time instance and the reference frequency for each entry of the measurement table, programming the DDS 143 at each time instance to tune to a respective reference frequency f_{ref} that corresponds to the measurement frequency fₘₑₛ for a chosen centre frequency f_{det} of the bandpass filter 125, iii) sending a signal to the ADC 140 to make a measurement, and iv) storing the result in the FPGA 22 or other on-board memory for use by the CRT 10. The SPM 222 is programmed to perform these steps, and controls the overall scan duration and periodicity by controlling measurement time, and controls the pattern over which frequencies are measured by controlling the DDS 143 output frequency.

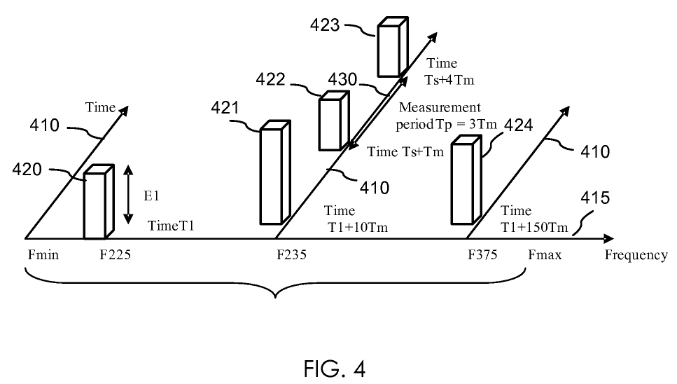

The method of the present invention will now be further described by way of example with reference to FIG. 4, which schematically illustrates time and frequency occupancy data obtained by the SM 100 within an operating radio band of the CRT 10 in one exemplary scenario. The following notations are used in this example:

Tm is a time interval between obtaining consecutive energy estimates, i.e. it includes the time required to conduct the measurement at a single reference frequency and the time required to retune the DDS 143 to the next measurement frequency. Tm depends on the DDS settling time, logamp settling time, an ADC conversion time, and reaction times in the FPGA 22 associated with programming of the DDS 143 and ADC 140 of the SM 100. Tp is the overall duration of a single scan, and also a time period for time-resolved spectrum measurements, such as at frequency F235=235 MHz as described hereinbelow. The frequency band in which the CRT 10 operates in this example spreads from Fmin=225 MHz to Fmax=400 MHz. By way of example, Tm=1 ms and Tp=3Tm=3 ms.

Again with reference to FIG. 4, axes 410 represent time, and axis 415 is a frequency axis spanning frequencies from Fmin to Fmax. Vertical rectangles 420-424 depict energy estimates as obtained in step 360, e.g. from the ADC 140 output, at measurement frequencies and time instances as labeled.

The spectrum monitor 100 is first tasked to scan the operating band from Fmin to Fmax searching for a transmission frequency in which the CRT 100 can operate using a pre-defined transmission bandwidth, for example 25 KHz as commonly used for narrow-band communications in the tactical UHF band. The measurement plan may be programmed into the SPM 222 by a host application such as the user, or the CR network, or a tasking authority, to first measure energy present at all frequencies from Fmin to Fmax in steps of δf=1 MHz. The measurement for each reference frequency in step 360 may be performed within a 1 MHz spectral bandwidth, as set by the bandwidth of the BPF 125 in FIG. 2 that defines the spectral resolution of the energy measurements.

Results of a spectrum scan performed for this measurement plan, which is referred to hereinafter as a coarse scan, are saved in memory in relation to time instances when particular measurements are performed, and are summarized in Table 1 in the form of a task list, where individual tasks are represented by table rows and correspond to a spectrum measurement at a single frequency at a particular time instance.

TABLE 1
A coarse scan task list.

| Task | Frequency | Time | Measurement |
|---|---|---|---|
| 1 | 225 | T1 | Energy at 225 MHz |
| 2 | 226 | T1 + Tm | Energy at 226 MHz |
| 3 | 227 | T1 + 2Tm | Energy at 227 MHz |
| 4 | 228 | T1 + 3Tm | Energy at 228 MHz |
| . . . | . . . | . . . | . . . |
| 175 | 399 | T1 + 174Tm | Energy at 399 MHz |

First two columns of Table 1 contain a list of measurement tasks, each corresponding to a particular measurement frequency, for the coarse spectrum scan. This task list may be implemented as sets of numbers loaded/programmed into the SPM-accessible memory, for example from a supervisory radio network. The SPM 222 may include a scan control module that is programmed to convert these tasks into FPGA output signals that control the spectrum monitor 100, in particular the DDS 143 and the ADC 140; for example, programming of Task 1 includes computing the DDS control word settings that correspond to the measurement frequency 225 MHz, programming a time setting T1dds that defines when this control word is to be provided to the DDS 143, and programming an ADC sampling time T1 that controls when the output of the ADC 140 is sampled by the FPGA 22. The ADC and DDS sampling times T1 and T1dds are synchronized to an onboard clock signal, with a relative time delay of at least the DDS settling time, but less than Tm. At the time instance T1dds the SPM 222 sends the DDS control word specifying a reference frequency 405 MHz=(225 MHz+180 MHz) corresponding to the desired measurement frequency of 225 MHz. At the time instance T1 the SPM 222 gates the ADC 140 and records its output signal E1, which is as an estimate of spectral energy of the input RF signal measured within the resolution bandwidth at frequency 225 MHz, and is also depicted at 420 in FIG. 4.

The energy estimate E1 is written into memory within the FPGA 22, or into external memory addressed from the FPGA, and tagged as that satisfying Task 1. Then Task 2, Task 3, and so on are implemented in a similar manner, with the ADC output recorded at time instance (T1+i·Tm) stored as related to Task i, with i spanning from 1 to 175. Once all tasks from Table 1 have been implemented, the resulting energy estimates are stored in relation to measurement frequencies and time instances when the respective measurements where taken, as illustrated by entrances into the final column in Table 1. The results may be conveyed to the host processor in any suitable manner, such as via a USB interface, by writing Table 1 entries into shared memory, etc.

Once such a coarse characterization of energy occupancy is obtained over the entire operating frequency band 225-400 MHz, the host radio network or a spectrum analysis algorithm programmed into the SPM 222 analyzes the obtained spectral energy table and on the basis of obtained data selects a particular portion of the operating band, for example for which the coarse scan yielded a particularly large energy estimate, for more detailed, such as time-resolved, monitoring.

In the exemplary scenario illustrated in FIG. 4, the coarse scan yielded energy estimates exceeding a pre-defined threshold, for example related to a noise floor of the measurement system, at measurement frequencies F225=225 MHz, F235=235 MHz, and F375=375 MHz, with the strongest signal detected at F235. The host radio network may be aware of external spectrum users that operates in a periodic manner in a narrow frequency band centered at F235, so that this band may be available for transmission on a time sharing basis when the CRT 10 uses this portion of the spectrum during the quiet times.

Accordingly, the spectrum processing module of the CRT 10 initiates time-resolved monitoring of a portion of the spectrum centered at 235 MHz, specifically at three measurement frequencies 234 MHz, 235 MHz and 236 MHz only. The fine time resolution is obtained by measuring the spectrum occupancy at these three frequencies repeatedly with a time period Tp to give the host radio network information from which the periodicity of the existing user transmission can be ascertained. Since only a few frequencies are now measured during each scan, each of these frequencies can be monitored with a much finer time resolution of Tp=3Tm than is possible when scanning across the entire operating band. The measurement plan for this scenario is summarized in the first three columns of Table 2, which specify a task identifier, a measurement frequency, and a time instance at which an energy estimate for each frequency is obtained, respectively.

TABLE 2
Fine spectrum scan task list.

| Task | Frequency | Time | Measurement |
|---|---|---|---|
| 1 | 234 | Ts | Energy at 234 MHz |
| 2 | 235 | Ts + Tm | Energy at 235 MHz |
| 3 | 236 | Ts + 2Tm | Energy at 236 MHz |
| 4 | 234 | Ts + 3Tm | Energy at 234 MHz |
| 5 | 235 | Ts + 4Tm | Energy at 235 MHz |
| 6 | 236 | Ts + 5Tm | Energy at 236 MHz |
| 7 | 234 | Ts + 6Tm | Energy at 234 MHz |
| . . . | . . . | . . . | . . . |
| 3000 | 236 | Ts + 2999Tm | Energy at 236 MHz |

Results of each spectrum scan performed for this time-resolved measurement plan are saved in memory in relation to respective measurement frequencies and time instances when particular measurements are performed, and are summarized in the forth column of Table 2.

As seen from Table 2, the task list provides for repeatedly measuring the spectrum energy at the three adjacent frequencies, 1000 times each. Turning again to FIG. 4, execution of task 1 from Table 2 includes obtaining an energy estimate 422 at fmes=234 MHz at a time instance Ts. The occupancy of 235 MHz is periodically measured at time instances Ts+Tm, Ts+4Tm, etc, resulting in energy estimates 422, 423, . . . . Table 2 summarizes spectral and temporal usage data for the plurality of monitored transmission frequencies 234, 235 and 236 MHz, which is stored and may be further analyzed by the host application or in the spectrum processing module of the CRT 10 to determine an occupancy time pattern for the 235 MHz transmission frequency, and to adaptively plan spectrum use for transmitting in available time slots so as to avoid the discovered use pattern. By performing time resolved measurements with a fine time resolution at the transmission frequencies on both sides of the 235 MHz channel, it is possible to resolve whether there are other periodic users in the adjacent bands.

Advantageously, the time resolution Tp of the fine spectral measurements at the selected frequency, which is 6 ms in this exemplary embodiment, is considerably less than the duration of a typical transmission timeslot in tactical TDMA (time domain multiplexed access) radio systems, which may be about 50 ms, so that the presence of external TDMA-based radio transmission on the selected measurement frequency F235 can be timely resolved. This is enabled by the ability of the spectrum monitor 100 to adaptively select sets of transmission frequencies to monitor, together with its ability to quickly switch from one measurement frequency to another.

This agility of the method in selecting monitored transmission frequencies is useful also for verifying that a measured frequency that has been selected by the CRT 10 for transmission after a spectrum scan continues to remain unoccupied during the transmission. For this purpose, the SPM 222 may be programmed to monitor the frequency selected for transmission during short intervals when the transmitter of the CRT 10 is idle and therefore the output RF signal of the CRT 10 will not interfere with the measurements, for example by including the current transmission frequency in a measurement plan to be monitored when the transmitter of the CRT 10 is idle or temporarily transmits at another frequency.

By way of example, after the coarse scan the spectrum processing module of the SPM 222 may determine that frequencies F230=230 MHz and F350=350 MHz are available for transmission, and tentatively allocate these frequencies as currently available for transmission. A new set of N=2 monitored transmission frequencies {fₘₑₛ}={F230, F350} consisting of the “tentatively available” frequencies may then be selected and a new time-resolved measurement plan similar to that represented in Table 2 may be programmed into the SPM 222. The digitally synthesized reference frequency may then be repeatedly stepped through reference frequency values corresponding to the set {fₘₑₛ}, with each frequency probed every Tp=N*Tm=4 ms time interval, which is sufficiently small to ensure that every TDMA time slot is probed within a large enough time interval, for example 1 sec. Energy estimates at the selected frequencies are then analyzed over the time of the time-resolved scan, and one or more of the probed frequencies {fₘₑₛ}, for example F350, is selected for transmission by the CRT 10 based on the time-resolved usage data for these frequencies. During the transmission at F350, the spectrum monitor 100 may perform the fine time-resolved measurement of the F235 spectrum band as described hereinabove with reference to Table 2 and FIG. 4. In another embodiment, the SPM 222 may also synchronize the spectrum monitoring with the RF transmission by the RF section of the CRT 10 so as to incorporate in the measurement plan occasional monitoring of the F350 transmission frequency in idle time intervals between the transmissions.

This agility of the RF spectrum monitoring provided by the present invention advantageously differentiates it from prior spectrum monitoring techniques and devices such as those based on analog local oscillators utilizing PLL loops, which lead to large latencies associated with each frequency change event, typically on the order several milliseconds or more. Also, the monitoring apparatus and method of the present invention provide advantages over FFT-based spectrum monitoring which require complex and time-consuming processing of the received time-dependent RF signal, and also require a broad-band front end which makes such devices vulnerable to over-loading by high-intensity interference sources within the detection band of the device.

The invention has been described hereinabove with reference to particular embodiments but is not limited thereto, and many other embodiments and variants of the method and apparatus described hereinabove may be envisioned by those skilled in the art. For example, although the concrete embodiments of the spectrum monitor 100 shown in FIG. 2 are described hereinabove with reference to the tactical UHF band 225-400 MHz, other embodiments may be designed to monitor other RF frequency bands, including but not limited to the military tactical VHF bands 30 MHz-108 MHz or 30 MHz-88 MHz, or a variable bandwidth switched-capacitor bandpass filter. Sub-GHz bands are preferable for longer-range radio communications because of better propagation properties at lower frequencies. However, the long ranges also mean that at an operating location the transceiver might see RF energy from other unrelated radio systems located far away, which adds to the importance of the RF spectrum monitoring in sub-GHz radios.

Furthermore, although the spectrum measurement circuit 103 of the spectrum monitor 100 shown in FIG. 2 has one down-conversion stage formed with the second mixer 120 and the fixed LO 142, this down-conversions stage may be absent in other embodiments the spectrum monitor of the present invention, for example those directed to lower RF transmission bands such as the 30 MHz-108 MHz band, where the down-conversion stage and the frequency doubler 117 may be omitted. In other embodiments, for example those directed to higher operating frequency bands such as in the GHz range, the spectrum measuring circuit 103 of the spectrum monitor 100 may utilize two or more frequency down-conversion stages, and the DLOC 102 may also utilize two or more frequency doublers, with additional amplifiers as required.

Moreover, alternative embodiments of the spectrum monitor 100 may utilize additional RF filters and or RF filters with frequency parameters differing from those given hereinabove with reference to FIG. 2, as may be routinely determined by a skilled technician as suitable for a particular application.

Furthermore, although the spectrum monitor 100 has been described hereinabove in reference to the CRT 10 and as a constituent part thereof, the spectrum monitor 100 can also be in the form of a device that is used in a radio communication system or network utilizing dynamic spectrum allocation and separately from any particular radio transceiver, for example as a stand-alone RF spectrum monitor or RF spectrum monitoring subs-system which communicates with a base station or the radio network to provide information about spectrum usage and available transmission frequencies for automatic central spectrum planning purposes.

Of course numerous other embodiments may be envisioned without departing from the spirit and scope of the invention as defined by the appended claims.

We claim:

1. A method of spectrum monitoring in a radio transceiver utilizing dynamic spectrum allocation for radio transmission, the method comprising the steps of:
(a) digitally synthesising a reference signal at a variable reference frequency corresponding to a monitored transmission frequency;
(b) mixing the digitally synthesized reference signal with an input radio signal received from an RF antenna to obtain a difference frequency signal;
(c) detecting the difference frequency signal at a detection frequency to obtain an estimate of the spectral energy of the input radio signal at the monitored transmission frequency; and,
(d) determining the availability of the transmission frequency using the spectral energy value.

2. A method according to claim 1, further comprising the step of frequency doubling of the reference frequency signal prior to step (b).

3. A method according to claim 1, further comprising the step of frequency down-converting of the difference frequency signal prior to step (c).

4. A method according to claim 1, further comprising the step of
(e) storing the spectral energy estimates in relation to the monitored transmission frequency or the respective reference frequency in memory.

5. A method according to claim 4, comprising the steps of:
(f) repeatedly performing the sequence of steps (a)-(c) while stepping the reference frequency through a plurality of reference frequency values so as to obtain spectral energy estimates for a plurality of monitored transmission frequencies;
(g) analyzing spectral energy estimates obtained in step (f) to obtain spectral and/or temporal usage data for the plurality of monitored transmission frequencies;
(h) adaptively changing the plurality of reference frequencies based upon the spectral and/or temporal usage data obtained in step (g); and,
(h) repeating step (f) to obtain spectral and/or temporal usage data for a different plurality of monitored transmission frequencies.

6. A spectrum monitor in a transceiver utilizing dynamic spectrum allocation and having a digital data processing and control (DDPC) section, an RF receiver section, and an RF transmitter section, the spectrum monitor comprising:
a) a direct digital synthesis (DDS) signal generator for digitally synthesising a reference signal at a variable reference frequency corresponding to a monitored transmission frequency;
b) an RF mixer connected to receive an input RF signal and the reference signal to output a mixed signal comprising a difference frequency signal;
c) a nonlinear device coupled to the RF mixer to receive the difference frequency signal for obtaining therefrom energy estimates for the input RF signal at the monitored transmission frequency in a selected measurement bandwidth;
d) an analogue to digital converter (ADC) for converting the detected signal into the digital domain; and,
e) a spectrum processing module within the DDPC section, the spectrum processing module coupled to the DDS signal generator and the ADC for controlling the variable reference frequency and for storing and processing the energy estimates.

7. A spectrum monitor according to claim 6, wherein the spectrum processing module is programmed to adaptively select a set of monitored transmission frequencies and a corresponding set of reference frequencies for providing said references frequencies to the DDS signal generator for stepping therethrough, and to record energy estimates obtained from the nonlinear device for estimating spectral and/or temporal occupancy pattern for the selected set of monitored transmission frequencies.

8. A spectrum monitor according to claim 6, further comprising a frequency doubler operatively connected between the DDS signal generator and the RF mixer for doubling the frequency of the reference signal prior to mixing thereof with the input RF signal.

9. A spectrum monitor according to claim 6, further comprising a second RF mixer and a local oscillator connected thereto, the second RF mixer operatively connected between the first RF mixer and the nonlinear device for down-converting the difference frequency signal.

10. A spectrum monitor according to claim 6, further comprising a passband filter of the selected bandwidth connected at the input of the nonlinear device to filter out frequency components of the difference frequency signal outside the selected bandwidth.
